(19) United States
(12) Patent Application Publication
(10) Pub. No.: US 2011/0158613 A1
(43) Pub. Date: Jun. 30, 2011

(54) PLAYBACK CONTROL APPARATUS AND PLAYBACK CONTROL METHOD

(75) Inventor: Naoki YAMANASHI, Ome-shi (JP)

(73) Assignee: Kabushiki Kaisha Toshiba, Tokyo (JP)

(21) Appl. No.: 12/939,059

(22) Filed: Nov. 3, 2010

(30) Foreign Application Priority Data
Dec. 28, 2009 (JP) 2009-297099

(51) Int. Cl. H04N 5/783

(52) U.S. Cl. 386/343; 386/E05.003

(57) ABSTRACT

According to one embodiment, a playback control apparatus includes a receiver, a memory, and a playback controller. The receiver is configured to receive data streams corresponding to a content in turn for each predetermined-length stream having a predetermined length. The memory is configured to sequentially store the predetermined-length streams received by the receiver. The playback controller is configured to control the receiver to start reception of the predetermined-length stream and to execute a playback process for playing back the predetermined-length streams stored in the memory in turn in response to a playback instruction.

### CROSS-REFERENCE TO RELATED APPLICATIONS

This application is based upon and claims the benefit of priority from Japanese Patent Application No. 2009-297099, filed Dec. 28, 2009; the entire contents of which are incorporated herein by reference.

### FIELD

Embodiments described herein relate generally to a playback control apparatus and playback control method, which allow to restart playback from a playback stop position of content data.

### BACKGROUND

In recent years, a network player, which accesses a network server and plays back streaming of content data, is commercially available. For example, the network player pauses a playback process, stores a playback paused position, and disconnects connection to the network server, in response to a playback pause instruction. Furthermore, the network player establishes connection to the network server again, and restarts the playback process from the playback paused position in response to a playback restart instruction. For example, the network player stores a playback paused position designated by playback time information from the beginning of content data, and restarts the playback process from this playback paused position. In this case, an actual playback stop position often has a slight difference from the playback restart position.

A technique that can eliminate such difference is demanded. For example, Jpn. Pat. Appln. KOKAI Publication No. 2009-111917 (reference 1) discloses a technique which can improve playback quality at the times of a pause instruction and pausing release instruction using time stamps in data received from an information delivery apparatus.

However, with the technique disclosed in reference 1 above, insertion intervals of time stamps often cause a difference between an actual playback stop position and playback restart position, and a technique that can attain high-precision alignment is demanded.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is a view for explaining an example of a first playback pause process and first playback restart process according to one embodiment;

FIG. 2 is a view for explaining an example of a second playback pause process and second playback restart process according to one embodiment;

FIG. 3 is a view for explaining an example of a third playback pause process and third playback restart process according to one embodiment;

FIG. 4 is a view showing an example of the outer appearance of a digital television broadcast receiver (playback control apparatus) according to one embodiment, and an example of a network system which mainly includes this digital television broadcast receiver; and

FIG. 5 is a block diagram showing an example of the digital television broadcast receiver according to one embodiment.

### DETAILED DESCRIPTION

Various embodiments will be described hereinafter with reference to the accompanying drawings.

In general, according to one embodiment, a playback control apparatus includes a receiver, a memory, and a playback controller. The receiver is configured to receive data streams corresponding to a content in turn for each predetermined-length stream having a predetermined length. The memory is configured to sequentially store the predetermined-length streams received by the receiver. The playback controller is configured to control the receiver to start reception of the predetermined-length stream and to execute a playback process for playing back the predetermined-length streams stored in the memory in turn in response to a playback instruction.

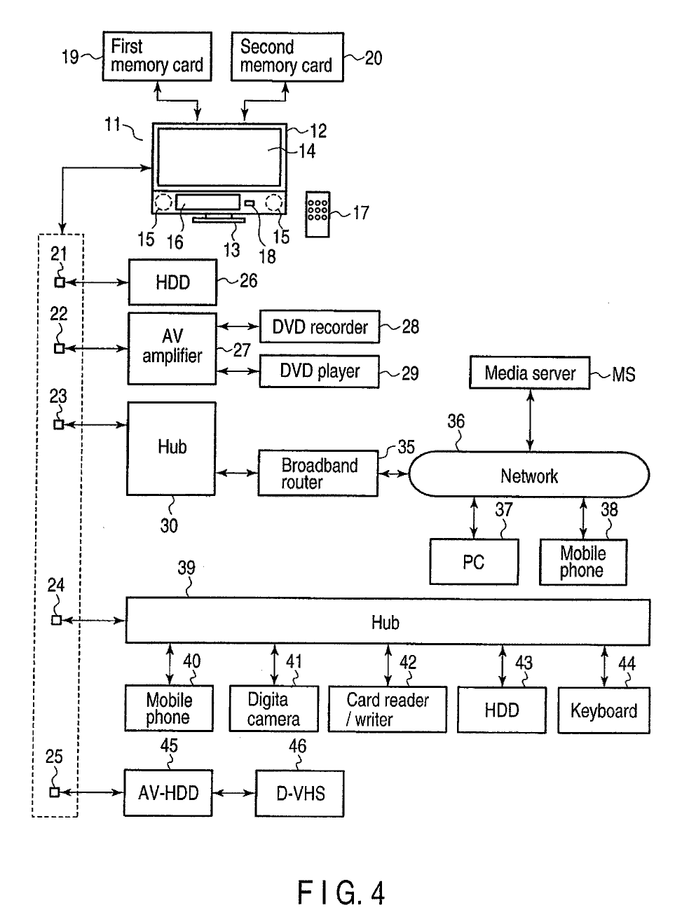

FIG. 4 schematically shows an example of the outer appearance of a digital television broadcast receiver (playback control apparatus) 11 according to one embodiment, and an example of a network system which mainly includes this digital television broadcast receiver 11.

More specifically, the digital television broadcast receiver 11 mainly includes a flat cabinet 12, and a support table 13 which supports this cabinet 12 in the standing position. In the cabinet 12, a flat-panel video display 14 including, e.g., a liquid crystal display panel, loudspeakers 15, an operation module 16, a light-receiving module 18 which receives operation information transmitted from a remote controller 17, and the like are arranged.

A first memory card 19 such as a Secure Digital (SD) memory card or a MultiMedia Card (MMC) is detachably attached to this digital television broadcast receiver 11. The receiver 11 records or plays back information such as programs and photos in or from this first memory card 19.

Furthermore, a second memory card [IC (Integrated Circuit) card] 20 which incorporates a semiconductor memory that records, e.g., contract information is detachably attached to this digital television broadcast receiver 11. The receiver 11 records or plays back information in or from the second memory card 20.

The digital television broadcast receiver 11 has a local area network (LAN) terminal 21, HDMI terminal 22, LAN terminal 23, Universal Serial Bus (USB) terminal 24, and i.LINK terminal 25.

The LAN terminal 21 is used as a LAN-compatible hard disk drive (HDD) dedicated port. The LAN terminal 21 is used to record and play back information in and from a connected LAN-compatible HDD 26 as connected network attached storage (NAS) via Ethernet®. In this way, since the LAN terminal 21 is arranged as the LAN-compatible HDD dedicated port, program information having high-definition image quality can be stably recorded on the HDD 26 without being influenced by other network environments, a network use state, and the like.

The LAN terminal 21 can also be used as a general LAN-compatible port using Ethernet®. For example, the LAN terminal 21 is used to connect, via, e.g., a hub, devices such as a LAN-compatible HDD 26, a personal computer (PC), a DVD recorder which incorporates an HDD 26, and network attached storage (NAS), and to exchange information with these devices.

The HDMI terminal 22 is connected to external devices such as a DVD recorder 28 and DVD player 29 via an AV amplifier 27.

The LAN terminal 23 is connected to a network 36 such as, for example, the Internet via a broadband router 35 connected to a hub 30, and is used to exchange information with a PC 37, mobile phone 38, media server MS, and the like via the network 36.

The USB terminal 24 is used as a general USB-compatible port, and is used to connect a mobile phone 40, digital camera 41, card reader/writer 42 for a memory card, HDD 43, keyboard 44, and the like via a hub 39, and to exchange information with these USB devices.

The i.LINK terminal 25 is used to serially connect, for example, an AV-HDD 45, Digital Video Home System (D-VHS) 46, and terrestrial digital tuner (not shown) and to exchange information with these devices.

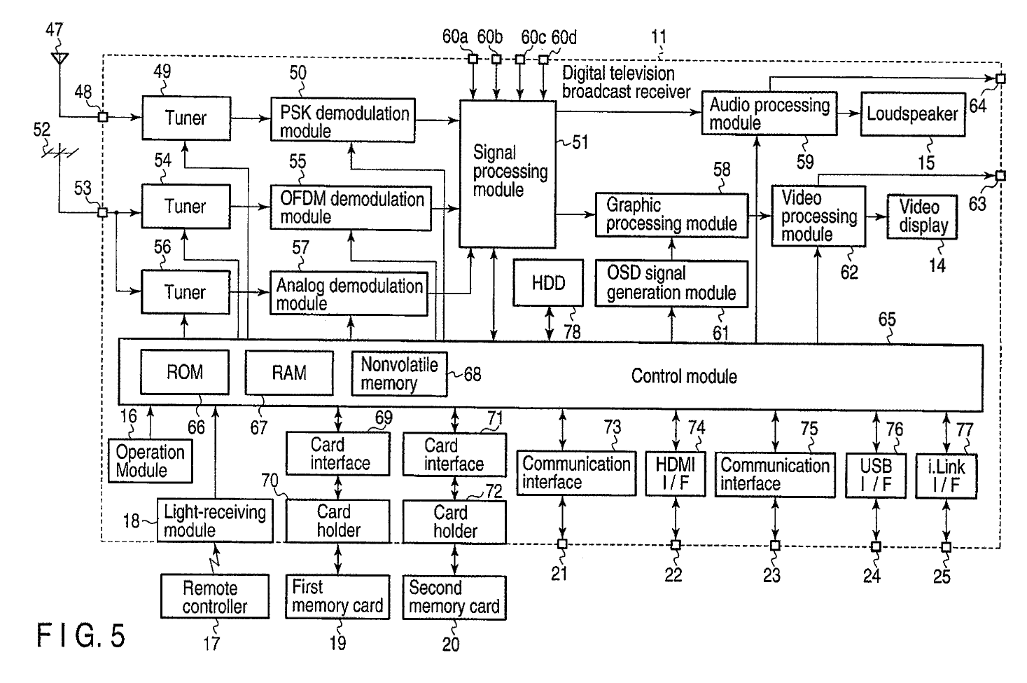

FIG. 5 shows a principal signal processing system of the aforementioned digital television broadcast receiver 11. More specifically, a satellite digital broadcast signal, which is received by a digital DBS receiving antenna 47, is supplied to a satellite digital broadcast tuner 49 via an input terminal 48, so as to tune a broadcast signal of a desired channel.

The broadcast signal tuned by this tuner 49 is supplied to a phase-shift keying (PSK) demodulation module 50, and is demodulated to obtain a digital video signal and audio signal, which are then output to a signal processing module 51.

A terrestrial digital television broadcast signal, which is received by a terrestrial broadcast receiving antenna 52, is supplied to a terrestrial digital broadcast tuner 54 via an input terminal 53, so as to tune a broadcast signal of a desired channel.

The broadcast signal tuned by this tuner 54 is supplied to an orthogonal frequency division multiplexing (OFDM) demodulation module 55, and is to demodulated to obtain a digital video signal and audio signal, which are then output to the signal processing module 51.

A terrestrial analog television broadcast signal, which is received by the terrestrial broadcast receiving antenna 52, is supplied to a terrestrial analog broadcast tuner 56 via the input terminal 53, so as to tune a broadcast signal of a desired channel. The broadcast signal tuned by this tuner 56 is supplied to an analog demodulation module 57, and is demodulated to obtain an analog video signal and audio signal, which are then output to the signal processing module 51.

The signal processing module 51 selectively applies predetermined digital signal processing to the digital video and audio signals respectively supplied from the PSK demodulation module 50 and OFDM demodulation module 55, and outputs the processed signals to a graphic processing module 58 and audio processing module 59.

To the signal processing module 51, a plurality of (four in FIG. 5) input terminals 60a, 60b, 60c, and 60d are connected. These input terminals 60a to 60d allow to respectively input analog video and audio signals from a device outside the digital television broadcast receiver 11.

The signal processing module 51 selectively converts the analog video and audio signals respectively supplied from the analog demodulation module 57 and input terminals 60a to 60d into digital video and audio signals, applies predetermined digital signal processing to the digital video and audio signals, and then outputs these signals to the graphic processing module 58 and audio processing module 59.

Of these processing modules, the graphic processing module 58 has a function of superimposing an on-screen display (OSD) signal generated by an OSD signal generation module 61 on the digital video signal supplied from the signal processing module 51, and outputting that signal. This graphic processing module 58 can selectively output the output video signal of the signal processing module 51 and the output OSD signal of the OSD signal generation module 61, or can combine and output these outputs to respectively form halves of the screen.

The digital video signal output from the graphic processing module 58 is supplied to a video processing module 62. This video processing module 62 converts the input digital video signal into an analog video signal having a format that can be displayed by the video display 14, and outputs the analog video signal to the video display 14 to display an image and also externally outputs it via an output terminal 63.

The audio processing module 59 converts the input digital audio signal into an analog audio signal having a format that can be played back by the loudspeakers 15, and outputs the analog audio signal to the loudspeakers 15 to play back a sound and also externally outputs it via an output terminal 64.

All operations including the aforementioned various receiving operations of the digital television broadcast receiver 11 are integrally controlled by a control module 65. This control module 65 incorporates, e.g., a central processing unit (CPU). The control module 65 receives operation information from the operation module 16 or that which is output from the remote controller 17 and is received by the light-receiving module 18, and controls respective modules to reflect the operation contents.

In this case, the control module 65 mainly uses a read-only memory (ROM) 66 which stores control programs executed by the CPU, a random access memory (RAM) 67 which provides a work area to the CPU, and a nonvolatile memory 68 which stores various kinds of setting information and control information.

The control module 65 is connected to a card holder 70, which can receive the first memory card 19, via a card interface 69. Thus, the control module 65 can exchange information with the first memory card 19 attached to the card holder 70 via the card interface 69.

Also, the control module 65 is connected to the LAN terminal 21 via a communication interface 73. Thus, the control module 65 can exchange information with the LAN-compatible HDD 26 connected to the LAN terminal 21 via the communication interface 73. In this case, the control module 65 has a Dynamic Host Configuration Protocol (DHCP) server function, and controls the LAN-compatible HDD 26 connected to the LAN terminal 21 by assigning an Internet Protocol (IP) address to it.

Furthermore, the control module 65 is connected to the HDMI terminal 22 via an HDMI interface 74. Thus, the control module 65 can exchange information with the devices connected to the HDMI terminal 22 via the HDMI interface 74. Moreover, the control module 65 is connected to the LAN terminal 23 via a communication interface 75. Thus, the control module 65 can exchange information with the devices connected to the LAN terminal 23 via the communication interface 75.

In addition, the control module 65 is connected to the USB terminal 24 via a USB interface 76. Thus, the control module 65 can exchange information with the devices (FIG. 4) connected to the USB terminal 24 via the USB interface 76.

Also, the control module 65 is connected to the i.LINK terminal 25 via an i.LINK interface 77. Thus, the control module 65 can exchange information, via the i.LINK interface 77, with the devices (FIG. 4) connected to the i.LINK terminal 25.

Furthermore, the control module 65 is connected to an HDD 78. Thus, the control module 65 can exchange information with the HDD 78.

As described above, the digital television broadcast receiver 11 includes the HDD 78 (internal HDD), and can further connect a plurality of information storage devices (a plurality of external storage devices). The external storage devices include, for example, NAS, an SD card, and an HDD. When an external storage device is connected, the control module 65 of the digital television broadcast receiver 11 can recognize the connected external storage device (can detect the accessible external storage device). When an external storage device is disconnected, the control module 65 can detect the disconnection of that external storage device (can detect the inaccessible external storage device).

First, second, and third playback pause processes, and first, second, and third playback restart processes will be described below. As described above, the digital television broadcast receiver 11 (to be referred to as a playback apparatus hereinafter) can establish connection to the media server MS via the network 36, and can play back streaming of content data in the media server MS.

For example, the control module 65 of the playback apparatus controls a reception operation, reception stop operation, reception restart operation, and the like of content data streams by the LAN terminal 23 and communication interface 75. The LAN terminal 23 and communication interface 75 receive (load) the content data streams in turn for each predetermined-length stream having a predetermined length. The control module 65 controls to sequentially store the received predetermined-length streams in a decoder buffer (to be referred to as a buffer hereinafter) including the nonvolatile memory 68. The control module 65 executes a playback process for playing back the streams stored in the buffer in response to a playback instruction input via the operation module 16 or that received by the light-receiving module 18. The control module 65 executes a first, second, or third playback pause process in response to a playback pause instruction (or a playback stop instruction) input via the operation module 16 or that received by the light-receiving module 18. Also, the control module 65 executes a first, second, or third playback restart process in response to a playback restart instruction input via the operation module 16 or that received by the light-receiving module 18.

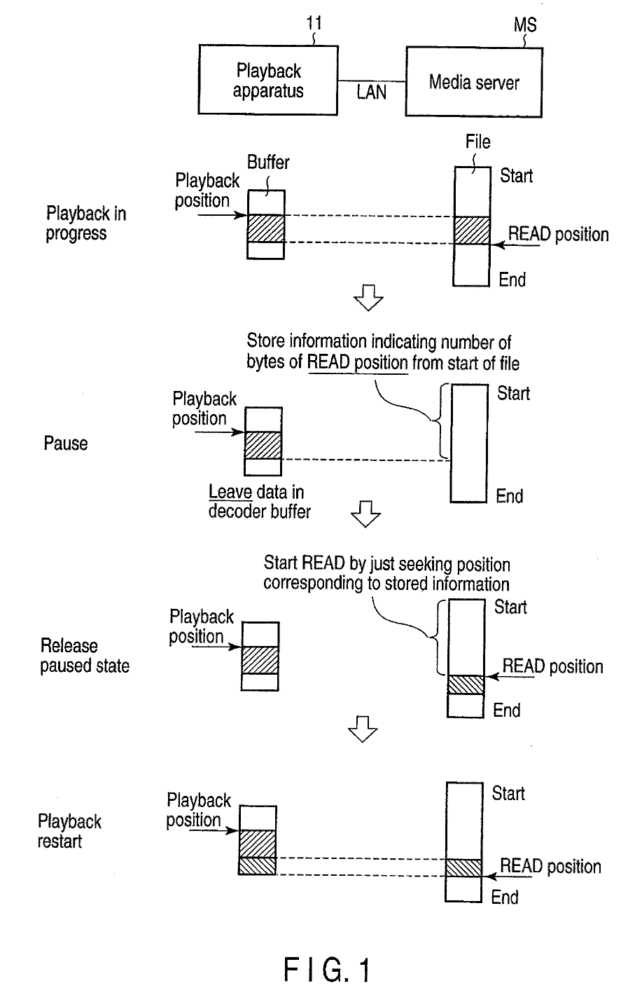

The first playback pause process and first playback restart process will be described below with reference to FIG. 1. The first playback pause process and first playback restart process can smoothly restart a playback process after its paused state is released.

As shown in FIG. 1, for example, the playback apparatus receives (loads) data streams (file) corresponding to a content in turn from the first stream for each predetermined-length stream having a predetermined length from the media server MS, and sequentially stores the received predetermined-length streams in the buffer. The playback apparatus then reads and plays back the predetermined-length streams stored in the buffer in turn in response to a playback instruction.

Subsequently, upon reception of a playback pause instruction, the playback apparatus stops the read process of the predetermined-length stream from the buffer (stops the playback process), and stores a playback stop position. The playback apparatus stops reception of the data streams while holding the predetermined-length streams stored in the buffer. Furthermore, the playback apparatus stores a data amount from a predetermined position of the data streams (for example, the number of bytes from the start position), which corresponds to a reception complete end position of the data streams (an end position of the predetermined-length stream stored in the buffer). That is, the playback apparatus stores information indicating the number of bytes from the predetermined position (e.g., the start position) of the data streams, which have been received (information indicating the number of bytes from the predetermined position of the data streams, which have been loaded).

Upon reception of a playback restart (paused state release and playback restart) instruction, the playback apparatus restarts the read process of the predetermined-length stream (restarts the playback process), restarts reception of the data streams from a position next to the reception complete end position corresponding to the data amount from the predetermined position (next byte position), and stores the data streams in turn from a predetermined-length stream obtained after the reception is restarted in the buffer.

That is, the read process of the predetermined-length stream from the buffer is stopped (the playback process is stopped) in response to the playback pause instruction. Next, the read process of the predetermined-length stream from the buffer is restarted (the playback process is restarted) in response to the playback restart instruction. Hence, the playback stop position and playback restart position are smoothly continued, and high-precision playback restart control from the playback stop position can be attained.

Since, for example, the number of bytes from the start position of the data streams, which corresponds to the reception complete end position of the data streams, is used, the reception complete position can be specified with high precision. Then, the predetermined-length stream stored in the buffer before the playback process is paused and that which is acquired and stored after the playback process is restarted are coupled, and the coupled streams are read and played back in turn, thus allowing to play back the data streams without any partially overlapping part and any partially omitted part.

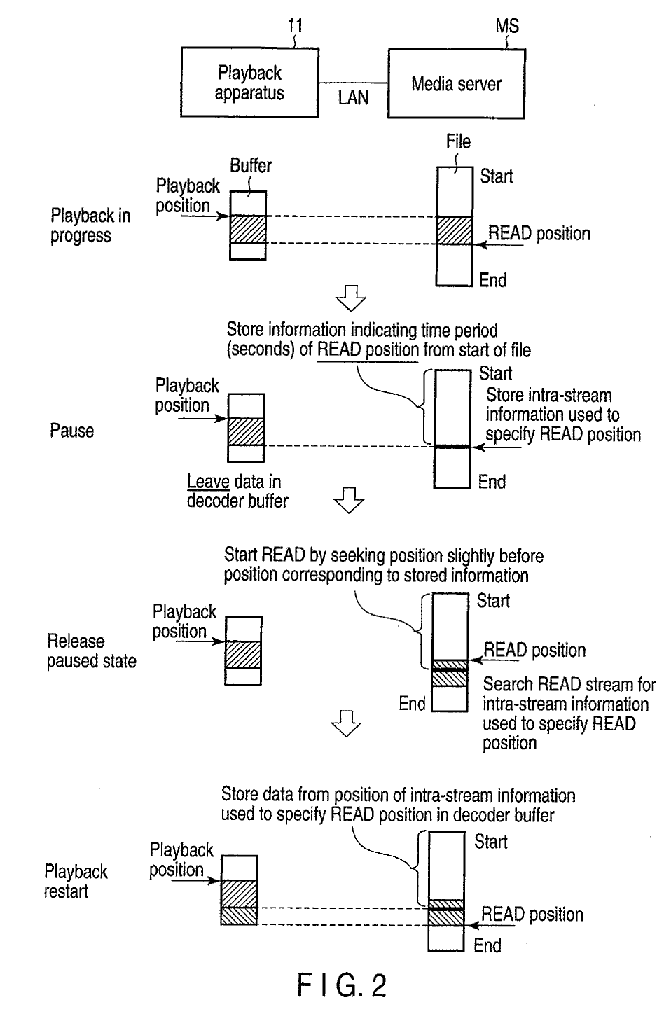

The second playback pause process and second playback restart process will be described below with reference to FIG. 2. The second playback pause process and second playback restart process can smoothly restart a playback process after its paused state is released.

As shown in FIG. 2, for example, the playback apparatus controls to receive (load) data streams (file) corresponding to a content in turn from the first stream for each predetermined-length stream having a predetermined length from the media server MS, and to sequentially store the received predetermined-length streams in the buffer. The playback apparatus then reads and plays back the predetermined-length streams stored in the buffer in turn in response to a playback instruction.

Subsequently, upon reception of a playback pause instruction, the playback apparatus stops the read process of the predetermined-length stream from the buffer (stops the playback process), and stores a playback stop position. The playback apparatus stops reception of the data streams (stops the playback process) while holding the predetermined-length streams stored in the buffer. Furthermore, the playback apparatus stores playback time information of the data streams which corresponds to a read complete position of the data streams (a playback complete position), and also acquires position specification information used to specify a reception complete end position (storage complete end position) from the predetermined-length stream. As the position specification information, the following data may be used.

For example, when a content data stream corresponding to a Moving Picture Experts Group (MPEG) 2 transport stream (TS), this content data stream includes Program Clock Reference (PCR) data, Presentation Time Stamp (PTS) data, and Decode Time Stamp (DTS) data at intervals of several hundred milliseconds. Hence, as the position specification information, these PCR, PTS, and DTS data can be used. When a content data stream corresponds to an MPEG2-TS with time stamp data, this content data stream includes PCR, PTS, DTS, and time stamp data at intervals of several hundred milliseconds. Hence, as the position specification information, these PCR, PTS, DTS, and time stamp data can be used. On the other hand, when a content data stream corresponds to an MPEG2 program stream (PS), this content data stream includes System Clock Reference (SCR) data, PTS data, and DTS data at intervals of several hundred milliseconds. Hence, as the position specification information, these SCR, PTS, and DTS data can be used.

Upon reception of a playback restart (paused state release and playback restart) instruction, the playback apparatus restarts the read process of the predetermined-length stream (restarts the playback process), and restarts the load (reception) process of the data streams from a position a predetermined time before the reception complete end position specified by the position specification information. The playback apparatus detects position specification information from the predetermined-length stream obtained after the reception is restarted, and stores streams in turn from data at a position next to the position specification information in the buffer again. The predetermined time will be described below. As described above, respective pieces of position specification information appear at predetermined time intervals. Hence, the predetermined time is set to be longer than this predetermined time interval. Then, the position specification information can be surely detected. Also, as described above, since the playback apparatus stores the playback time information of the data streams, which corresponds to the read complete position (playback complete position) of the data streams, this playback time information is used, and the load (reception) process of the data streams can be restarted from a position the predetermined time before this playback time information.

As described above, the read process of the predetermined-length stream from the buffer is stopped (the playback process is stopped) in response to the playback pause instruction. Next, the read process of the predetermined-length stream from the buffer is restarted (the playback process is restarted) in response to the playback restart instruction. Hence, the playback stop position and playback restart position are smoothly continued, and high-precision playback restart control from the playback stop position can be attained.

Since the position specification information of the content data streams is used, the reception complete position can be specified with high precision. As described above, the playback apparatus stores predetermined-length streams until the position specification information in the buffer in response to the playback stop instruction, maintains a state in which the predetermined-length streams stored in the buffer are held, and sequentially stores predetermined-length streams after the position specification information in the buffer in response to the playback restart instruction later. In this way, the playback apparatus continuously reads, in turn, the predetermined-length streams stored in the buffer before the playback process is paused and those which are to be acquired and stored in the buffer after the playback process is restarted, thus allowing to play back the data streams without any partially overlapping part and any partially omitted part.

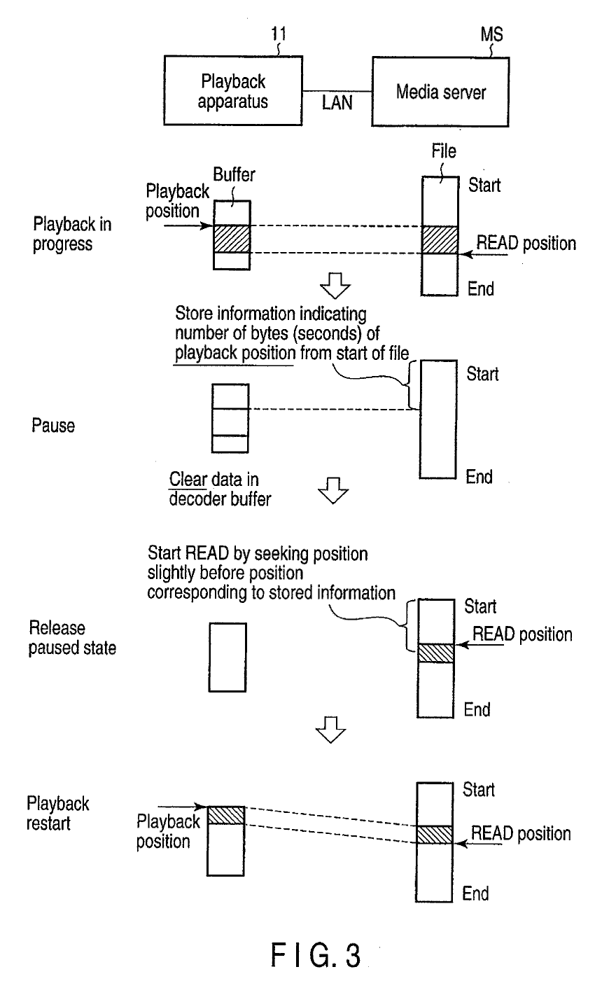

The third playback pause process and third playback restart process will be described below with reference to FIG. 3.

As shown in FIG. 3, for example, the playback apparatus controls to receive (load) data streams (file) corresponding to a content in turn from the first stream for each predetermined-length stream having a predetermined length from the media server MS, and to sequentially store the received predetermined-length streams in the buffer. The playback apparatus then reads and plays back the predetermined-length streams stored in the buffer in turn in response to a playback instruction.

Subsequently, upon reception of a playback pause instruction, the playback apparatus stops the read process of the predetermined-length stream from the buffer (stops the playback process), and stores a playback stop position. The playback apparatus stops the reception (load) process of the data streams, and stores playback time information of the data streams which corresponds to a read complete position (playback complete position) of the data streams. The playback apparatus clears the predetermined-length streams stored in the buffer. That is, the playback apparatus stores information indicating a time period (hours, minutes, and seconds) in which streams have been loaded from a predetermined position (e.g., a start position) of the data streams (information indicating the time period in which streams have been played back), and clears the predetermined-length streams stored in the buffer.

Upon reception of a playback restart (paused state release and playback restart) instruction, the playback apparatus restarts the reception (load) process of the data streams from a position next to the read complete position corresponding to the playback time information, sequentially stores streams in turn from a predetermined-length stream obtained after the reception is restarted, and restarts the read process of the stored predetermined-length streams (restarts the playback process).

The playback apparatus of this embodiment can also selectively use the aforementioned first, second, and third playback pause processes and first, second, and third playback restart processes depending on the situation. For example, when data streams can be received (loaded) by designating a data amount, the first playback pause process and first playback restart process are executed. When data streams cannot be received (loaded) by designating a data amount, the second playback pause process and second playback restart process or the third playback pause process and third playback restart process are executed.

For example, when the media server MS accepts a byte designation seek, the playback apparatus executes the first playback pause process and first playback restart process. When the media server MS does not accept any byte designation seek but it accepts a time designation seek, and position specification information is available, the playback apparatus executes the second playback pause process and second playback restart process. When the media server MS does not accept any byte designation seek but accepts a time designation seek, and position specification information is not available, the playback apparatus executes the third playback pause process and third playback restart process. As described above, the playback apparatus, which acquires streams from the media server MS, can execute the playback pause process and playback restart process depending on the situation.

In case of the playback apparatus (client), which acquires streams from the media server MS, connection to the media server MS is often disconnected in response to the playback stop instruction. The reason for disconnection of the connection will be additionally described below. When the playback apparatus does not access the server for a predetermined time period, the server disconnects connection to the playback apparatus. For this reason, streaming playback processing, which plays back contents from the media server MS, encounters disconnection of the connection when the playback process is paused unlike a playback process of data stored on, e.g., an HDD.

As described above, a designation method of a seek position to the media server MS includes, for example, two methods, i.e., byte designation and time designation. When a byte designation seek is not accepted, it is inconvenient that only the third playback pause process and third playback restart process are used. This is because the third playback pause process and third playback restart process have playback restart position precision inferior to the first playback pause process and first playback restart process or the second playback pause process and second playback restart process, since these processes use the playback time information. At the playback restart timing, it is not allowed to start playback from a position ahead of the playback stop position. For this reason, in the third playback pause process and third playback restart process, a position about 1 second before the playback stop position is set as the playback restart position, and the playback process is restarted from this playback restart position.

As described above, the third playback pause process and third playback restart process have inferior playback restart position precision. The playback apparatus of this embodiment selectively uses the first, second, and third playback pause processes and first, second, and third playback restart processes depending on the situation, thus exhibiting optimal performance.

For example, when a byte designation seek can be accepted, the playback apparatus executes the first playback pause process and first playback restart process. Even when a byte designation seek is not accepted, when position specification information is available, the playback apparatus executes the second playback pause process and second playback restart process, and can restart the playback process from the playback stop position with high precision. Even in a situation in which the media server MS does not accept any byte designation seek, and position specification information is not available, the playback apparatus executes the third playback pause process and third playback restart process, thus restarting the playback process nearly from the playback stop position.

The various modules of the embodiments described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A playback control apparatus comprising:
a receiver configured to receive data streams corresponding to a content in turn for each predetermined-length stream having a predetermined length;
a memory configured to sequentially store the predetermined-length streams received by the receiver; and
a playback controller configured to control the receiver to start reception of the predetermined-length stream and to execute a playback process for playing back the predetermined-length streams stored in the memory in turn in response to a playback instruction, to control to stop the playback process of the predetermined-length streams stored in the memory and to control the receiver to stop reception of the data streams in response to a playback stop instruction, to execute a first playback stop process for storing a data amount from a predetermined position of the data streams, which corresponds to a reception complete end position of the data streams, in response to the playback stop instruction, to control to restart the playback process of the predetermined-length streams stored in the memory and to control the receiver to restart reception of the data streams from a position next to the reception complete end position corresponding to the data amount from the predetermined position in response to a playback restart instruction, and to execute a first playback restart process for storing streams in turn from the predetermined-length stream obtained after the reception is restarted in the memory in response to the playback restart instruction.

2. The apparatus of claim 1, wherein the playback controller is configured to control to stop the playback process of the predetermined-length streams stored in the memory and to control the receiver to stop reception of the data streams in response to the playback stop instruction, and to execute the first playback stop process for storing the number of bytes from a start position of the data streams, which corresponds to a reception complete end position of the data streams, in response to the playback stop instruction.

3. The apparatus of claim 1, wherein the playback controller is configured to control to stop the playback process of the predetermined-length streams stored in the memory and to control the receiver to stop reception of the data streams in response to the playback stop instruction, and to execute a second playback stop process for acquiring position specification information used to specify a reception complete end position from the predetermined-length stream in response to the playback stop instruction, and
the playback controller is configured to control to restart the playback process of the predetermined-length streams stored in the memory and to control the receiver to restart reception of the data streams from a position a predetermined time before the reception complete end position specified by the position specification information in response to the playback restart instruction, and to execute a second playback restart process for detecting the position specification information from the predetermined-length stream obtained after the reception is restarted and storing streams in turn from data at a position next to the position specification information in the memory in response to the playback restart instruction.

4. The apparatus of claim 3, wherein the playback controller is configured to store the predetermined-length streams until the position specification information in response to the playback stop instruction, and to sequentially store the predetermined-length streams after the position specification information in the memory in response to the playback restart instruction.

5. The apparatus of claim 1, wherein the playback controller is configured to control to stop the playback process of the predetermined-length streams and to control the receiver to stop reception of the data streams in response to the playback stop instruction, and to execute a second playback stop process for storing playback time information of the data streams, which corresponds to a reception complete position of the data streams in response to the playback stop instruction, and
the playback controller is configured to control the receiver to restart reception of the data streams from a position next to the reception complete position corresponding to the playback time information and to store streams in turn from the predetermined-length stream obtained after the reception is restarted in the memory in response to the playback restart instruction, and to execute a second playback restart process for restarting the playback process of the predetermined-length streams stored in the memory in response to the playback restart instruction.

6. The apparatus of claim 3, wherein the playback controller is configured to execute the first playback stop process and the first playback restart process when the receiver is configured to receive the data streams by designating a data amount, and to execute the second playback stop process and the second playback restart process when the receiver is configured not to receive the data streams by designating a data amount.

7. The apparatus of claim 5, wherein the playback controller is configured to execute the first playback stop process and the first playback restart process when the receiver is configured to receive the data streams by designating a data amount, and to execute the second playback stop process and the second playback restart process when the receiver is configured not to receive the data streams by designating a data amount.

8. The apparatus of claim 3, wherein the playback controller is configured to control the receiver to restart reception of the data stream from a position the predetermined time before, the predetermined time being longer than an appearance interval of the position specification information.

9. A playback control apparatus comprising:
a receiver configured to receive data streams corresponding to a content in turn for each predetermined-length stream having a predetermined length;
a memory configured to sequentially store the predetermined-length streams received by the receiver; and
a playback controller configured to control the receiver to start reception of the predetermined-length streams and to execute a playback process for playing back the predetermined-length streams stored in the memory in response to a playback instruction, to control to stop the playback process of the predetermined-length streams stored in the memory and to control the receiver to stop reception of the data streams in response to a playback stop instruction, to execute a playback stop process for acquiring position specification information used to specify a reception complete end position from the predetermined-length stream in response to the playback stop instruction, to control to restart the playback process of the predetermined-length streams and to control the receiver to restart reception of the data streams from a position a predetermined time before the reception complete end position specified by the position specification information in response to a playback restart instruction, and to execute a playback restart process for detecting the position specification information from a predetermined-length stream obtained after the reception is restarted and sequentially storing streams in turn from data at a position next to the position specification information in the memory in response to the playback restart instruction.

10. A playback control method comprising:
executing a playback process for receiving data streams corresponding to a content for each predetermined-length stream having a predetermined length, sequentially storing the received predetermined-length streams, and playing back the stored predetermined-length streams in turn in response to a playback instruction;
controlling to stop the playback process of the predetermined-length streams and controlling to stop reception of the data streams in response to a playback stop instruction, and executing a playback stop process for storing a data amount from a predetermined position of the data streams, which corresponds to a reception complete end position of the data stream in response to the playback stop instruction; and
controlling to restart the playback process of the stored predetermined-length streams and controlling to restart reception of the data streams from a position next to the reception complete end position corresponding to the data amount from the predetermined position in response to a playback restart instruction, and executing a playback restart process for storing streams in turn from the predetermined-length stream obtained after the reception is restarted in response to the playback restart instruction.
